(19) United States
(12) Patent Application Publication
(10) Pub. No.: US 2020/0236129 A1
(43) Pub. Date: Jul. 23, 2020

(54) SYSTEMS AND METHODS FOR VULNERABILITY SCORECARD

(71) Applicant: ServiceNow, Inc., Santa Clara, CA (US)

(72) Inventor: David Victor Barkovic, San Francisco, CA (US)

(21) Appl. No.: 16/750,689

(22) Filed: Jan. 23, 2020

Related U.S. Application Data
(60) Provisional application No. 62/796,003, filed on Jan. 23, 2019.
(60) Provisional application No. 62/795,944, filed on Jan. 23, 2019.

(51) Int. Cl. H04L 29/06; H04L 12/26; H04L 12/24

(52) U.S. Cl. CPC H04L 63/1433; H04L 41/22; H04L 43/045

(57) ABSTRACT

A vulnerability scorecard correlates a vulnerability detected for a network-connected host with an underlying CI, services that may my run on, depend from, or otherwise utilize the CI, and the service owners responsible for the services. The vulnerability scorecard may include a GUI that includes window, widgets, and/or other visualizations that represent data related to the vulnerabilities, CIs, services, service owners, etc. The vulnerability scorecard widgets may be separated into groups and distributed over pages organized by tabs.

### CROSS-REFERENCE TO RELATED APPLICATIONS

This application claims priority to and benefit of U.S. Provisional Patent Application No. 62/795,944, entitled “SYSTEMS AND METHODS FOR VULNERABILITY SCORECARD”, filed on Jan. 23, 2019, and U.S. Provisional Patent Application No. 62/796,003, entitled “SYSTEMS AND METHODS FOR VULNERABILITY SCORECARD”, filed on Jan. 23, 2019, both of which are hereby incorporated by reference in their entireties.

### BACKGROUND

The present disclosure relates generally to identifying and monitoring vulnerabilities of a computer network and, more specifically, to techniques for categorizing and prioritizing vulnerabilities.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations, which resources may be used to perform a variety computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able redirect their resources to focus on their enterprise's core functions.

Network vulnerabilities are identified by an internet protocol (IP) address of a network resource experiencing the vulnerability. However, it may be difficult to categorize and prioritize vulnerabilities for remediation based solely on the identity of the network resource experiencing the problem. Further, it may be difficult to assess whether vulnerabilities are being addressed in a timely and efficient manner. Accordingly, it may be desirable to obtain some context for the network vulnerabilities before prioritizing the vulnerabilities for remediation.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The disclosed techniques include a vulnerability scorecard that correlates a vulnerability detected for a network-connected host with an underlying CI, services that may run on, depend upon, or otherwise utilize the CI, and the service owners responsible for the services. The vulnerability scorecard may include a graphical user interface (GUI) that includes window, widgets, and/or other visualizations that represent data related to the vulnerabilities, CIs, services, service owners, etc. The vulnerability scorecard widgets may be separated into groups and distributed over pages organized by tabs.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables the client instance, in accordance with aspects of the present disclosure;

FIG. 5 is a block diagram of an embodiment of an electronic computing and communication system for discovering and/or managing connected configuration items (CIs) connected to a network, in accordance with aspects of the present disclosure;

FIG. 6 is a screenshot of a graphical user interface (GUI) that lists how a service relates to other services and CIs within the network, in accordance with aspects of the present disclosure;

FIG. 7 is a screenshot of a GUI displaying an example of an expanded service map, in accordance with aspects of the present disclosure;

FIG. 8 shows the service map of FIG. 7 in collapsed form, in accordance with aspects of the present disclosure;

FIG. 9 illustrates an overview tab of the Vulnerability Scorecard, in accordance with aspects of the present disclosure;

FIG. 10 illustrates a business services tab of the Vulnerability Scorecard of FIG. 9, in accordance with aspects of the present disclosure;

FIG. 11 illustrates an embodiment of the business services tab of the Vulnerability Scorecard of FIG. 9 in which the “High Vulnerable Items” group is displayed according to a Pareto visualization, in accordance with aspects of the present disclosure;

FIG. 12 illustrates an embodiment of the business services tab of the Vulnerability Scorecard of FIG. 9 in which the “High Vulnerable Items” group is displayed according to a treemap visualization, in accordance with aspects of the present disclosure;

FIG. 13 illustrates a service owners tab of the Vulnerability Scorecard of FIG. 9, in accordance with aspects of the present disclosure;

FIG. 14 shows an analytics hub window displaying information about business services in a “High Vulnerable Items” group of FIG. 13 that are owned by James Vittolo, in accordance with aspects of the present disclosure;

FIG. 15 illustrates a plot of the number of vulnerabilities in the “High Vulnerable Items” group that are owned by James Vittolo, broken down by business service, with each line representing a business service, in accordance with aspects of the present disclosure;

FIG. 16 illustrates a vulnerable CIs tab of the Vulnerability Scorecard of FIG. 9, in accordance with aspects of the present disclosure;

FIG. 17 illustrates an exceptions tab of the Vulnerability Scorecard of FIG. 9, in accordance with aspects of the present disclosure;

FIG. 18 is illustrates a remediation tab of the Vulnerability Scorecard of FIG. 9, in accordance with aspects of the present disclosure; and

FIG. 19 is a flow chart of a process for receiving vulnerability data, processing the vulnerability data, and populating a GUI (e.g., a vulnerability scorecard) based on the vulnerability data.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

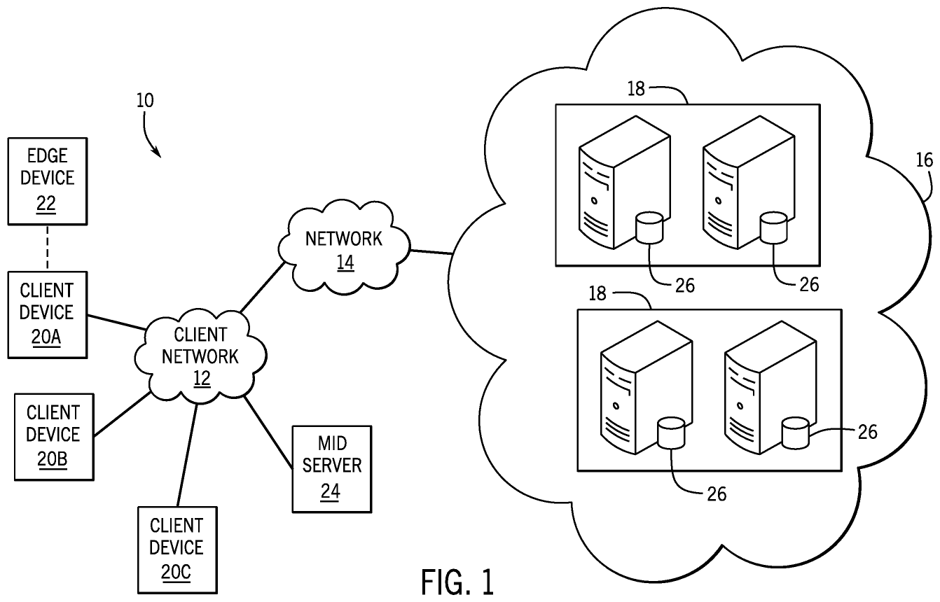

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

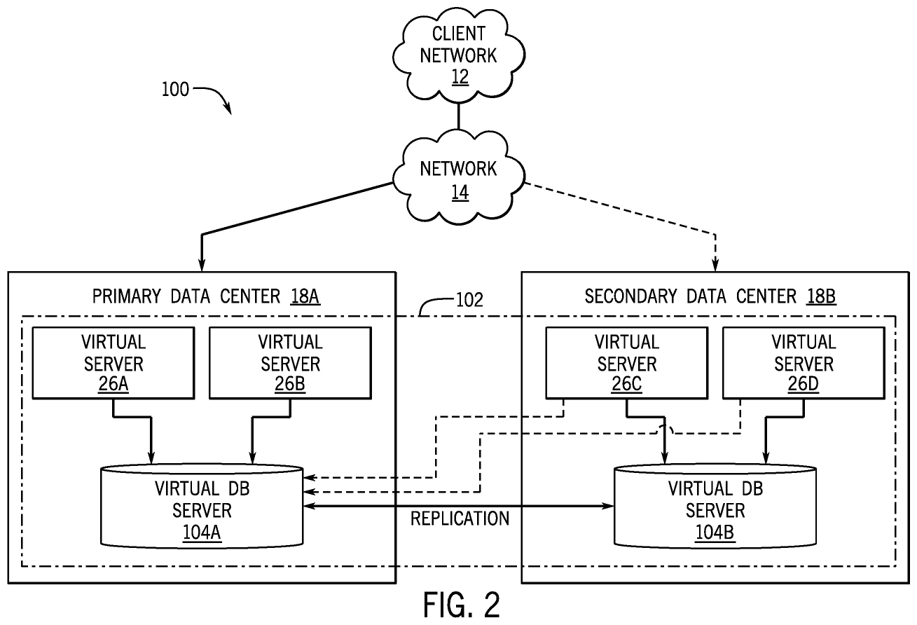

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

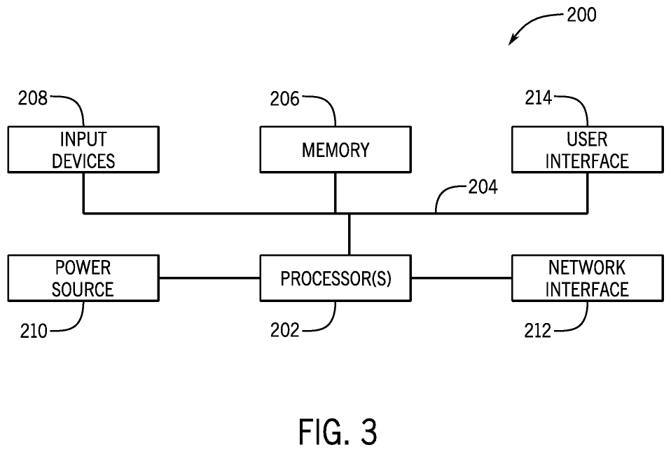

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

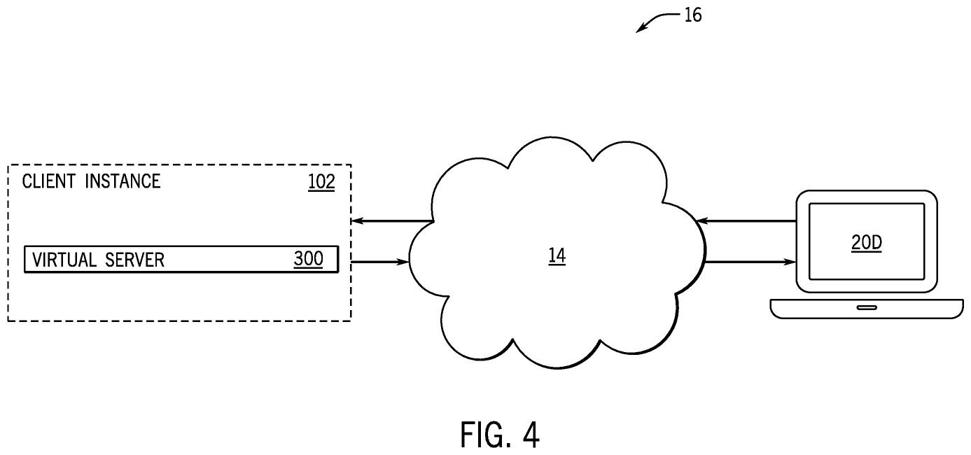

With the preceding in mind, FIG. 4 is a block diagram illustrating an embodiment in which a virtual server 250 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20D via the network 14 to provide a user interface to network applications executing within the client instance 102 (e.g., via a web browser of the client device 20D). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device 20D, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

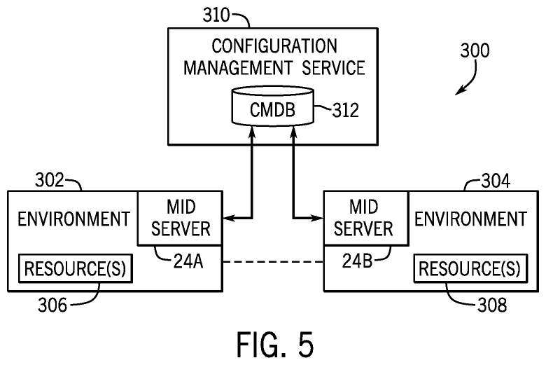

FIG. 5 is a block diagram of an embodiment of an electronic computing and communication system 300 for discovering and/or managing connected configuration items. The electronic computing and communication system 300 includes one or more environments such as environments 302 and 304 each including resources 306 and 308, respectively. Each environment 302, 304 may include one or more networks coupling resources together in a location-based, function-based, and/or common credentials-based grouping.

For example, the environments 302, 304 may include a customer service environment used to represent customer service infrastructure in a technical support, sales, billing, and/or other groupings. Similarly, the environments 302, 304 may include a datacenter and all devices coupled to one or more networks located at the datacenter. Additionally or alternatively, the environment 302, 304 may be distributed across multiple geographical locations. Thus, the environment 302, 304 may include any devices that are accessible by a user account including resources that may be spatially distant from each other. In some embodiments, resources 306, 308 of the environments 302, 304 may communicate with each other across environments. However, in some embodiments, aspects of various environments may be provided by different vendors without communication there between. In such embodiments, the resources of disparate environments may communicate using the platform (e.g., a configuration management service 310 that is a part of a cloud service platform including a CMDB 312). The resources 306 and 308 may include any suitable configuration item.

The configuration management service 310 may include one or more servers providing access to and managing the CMDB 312. The configuration management service 310 may allocate or provision resources, such as application instances in the resources 306 or 308 from a respective environment 302 or 304. Further, the configuration management service 310 may create, modify, or remove information in the CMDB 312 relating to the resources 306 or 308. Thus, the configuration management service 310 may manage a catalogue of resources in more than a single environment (even if the environments may not directly communicate with each other). Using this catalogue, the configuration management service 310 may discover new resources, provision resources, allocate resources, modify, and/or remove resources from the catalogue across a single environment or multiple environments. In some embodiments, these actions may be initiated as part of an operation executed on a client instance 102, may be scheduled for periodic occasions (e.g., periodic discovery), or may be a combination thereof. For example, a client instance 102 may receive a request, via its input structures, to query an identity of an application program interface (API) used by a resource to access a particular vendor/provider for the first environment 302 that is passed to the configuration management service 310 to query the CMDB 312. As another example, the client instance 102 may receive a request, via its input structures, to query an identity of a user authorized to access a particular resource that is passed to the configuration management service 310.

As previously discussed, the CMDB 312 may be populated utilizing a discovery process which may be used to discover the resources 306 or 308. Moreover, as previously discussed, the discovery process may include determining the properties or attributes of the resources 306 or 308 in their respective environments 302 or 304 using a respective MID server 24A or 24B. In the illustrated embodiment, each environment 302 and 304 has its own MID server 24A, 24B. In some embodiments, a single MID server may be employed when the MID server may reach into multiple environments. For example, if the MID server is run in the platform 16 shown in FIG. 1 (e.g., in the configuration management service 310), a single MID server may be used to manage both environments 302 and 304. Additionally or alternatively, if the MID server 24A of the first environment 302 has access to the second environment 304, the MID server 24B of the second environment 304 may be omitted.

As previously discussed, each discovered resource is identified as a configuration item (CI) with a record stored in the CMDB 312 including data indicating properties, attributes, dependencies, or other information about the resource. The CMDB 312 may be encoded, for example, as a relational database management system (RDBMS); an object-oriented database (e.g. an XML database); a network model database; or a flat-file database.

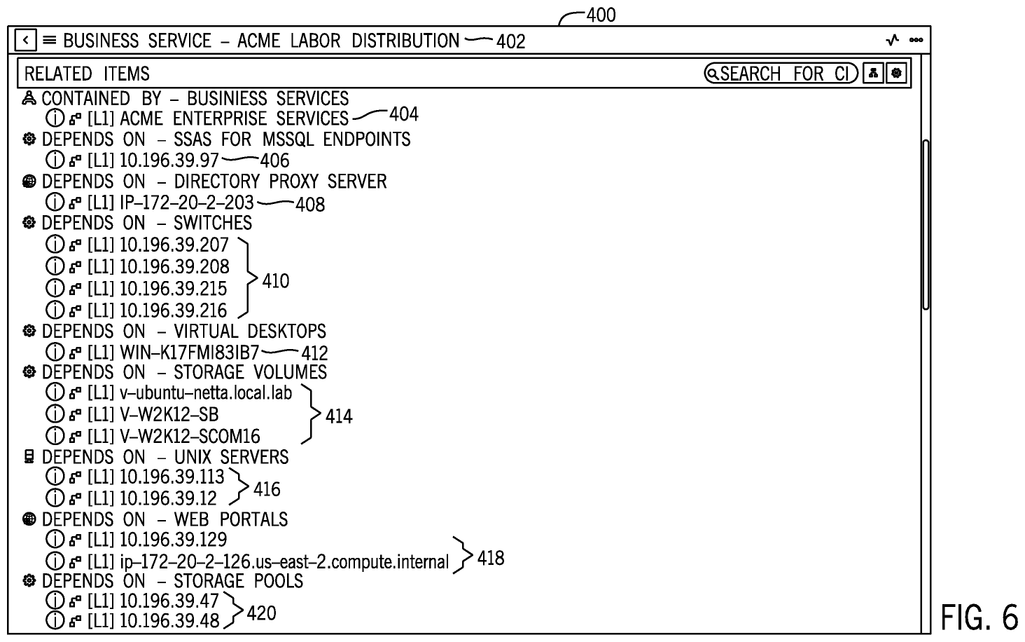

As may be appreciated, over time, configuration files used by the CIs may change. As previously noted, in systems with multiple CIs it may be difficult and/or time-consuming to examine the configuration files to determine where or when changes are made to various files. Accordingly, a discovery process may be run periodically to discover new CIs or changes to existing CIs. The discovery process may then determine the relationship and dependencies between the various CIs within a network and the services or software packages running on those CIs. For example, FIG. 6 is a screenshot 400 of a graphical user interface (GUI) that illustrates, in list form, how a service (e.g., “ACME Labor Distribution” 402) relates to other services and CIs within the network. For example, the service 402 in question may be contained within a larger service (e.g., “ACME Enterprise Services” 404). In some embodiments, the service in question may depend on other services, and/or other services may depend from the service 402 in question. Further, as shown, the service 402 in question may depend on or otherwise utilize hardware or other resources of a network (e.g., servers, proxy servers, endpoints, switches, virtual desktops, storage volumes, portals, storage pools, etc.), represented by CIs, in order to operate. As shown in FIG. 6, CIs may be grouped into categories (e.g., endpoints, proxy servers, switches, virtual machines/desktops, storage volumes, servers, web portals, storage pools, etc.). These categories may be based on CI attributes (e.g., class, type, etc.) that are automatically determined or provided by a user. In other embodiments, some or all of the CIs maybe manually grouped (e.g., by an administrator). As shown, each CI may be represented by an alphanumeric character string. The alphanumeric character strings may correspond to an internet protocol (IP) address, a MAC address, a serial number, a name given to a component by a user or automatically generated according to some naming convention. In other embodiments, the alphanumeric character string for a CI may be generated using a regular expression (regex). For example, in the embodiment shown in FIG. 6, the ACME Labor Distribution service 402 depends on a group of SSAS for MSSQL endpoints 406, a directory proxy server 408, a group of switches 410, a virtual desktop 412, a group of storage volumes 414, a group of UNIX servers 416, a group of web portals 418, and a group of storage pools 420.

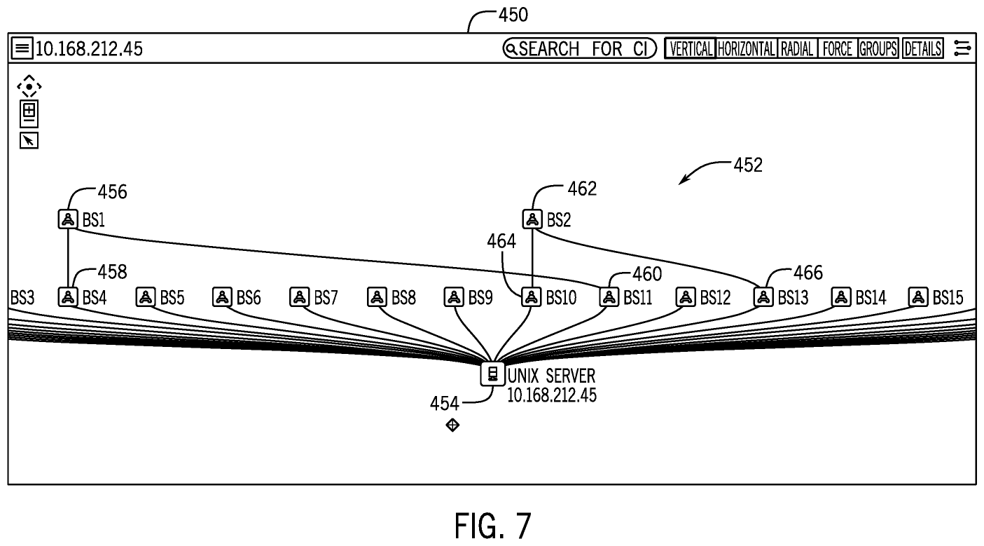

In addition to list form (e.g., as shown in FIG. 6), relationships between CIs and services can be visually illustrated in map view, such as a service map. A service map (e.g., a visual representation of CIs, services and/or software running on the CIs, and/or operations and the relationships between the various CIs, services, and/or operations) may be generated for display to a user. As the discovery process is run periodically, the service map may be updated to reflect changes recognized during the discovery process. FIG. 7 is a screenshot 450 of a GUI displaying an example of an expanded service map 452. As shown, multiple different services (e.g., business services) are running on a UNIX server 454, which is represented by a CI. Each business service is represented by the letters “BS” and a number that corresponds to a number of the business service. Each business service may correspond to, for example, purchasing, procurement, IT services, email, human resources, accounting, payment processing, inventory, maintenance, etc. As shown, some of the services are dependent on other services running on the same CI or different CIs, as indicated by lines or “edges” connecting the various CIs. For example, BS1 456 is dependent upon BS4 458 and BS11 460. Similarly, BS2 462 is dependent upon BS10 464 and BS13 466. It should be understood, however, that the service map 452 shown in FIG. 7 is merely an example and that other service maps are also envisaged. For example, in some embodiments, a service map may include multiple levels of dependency.

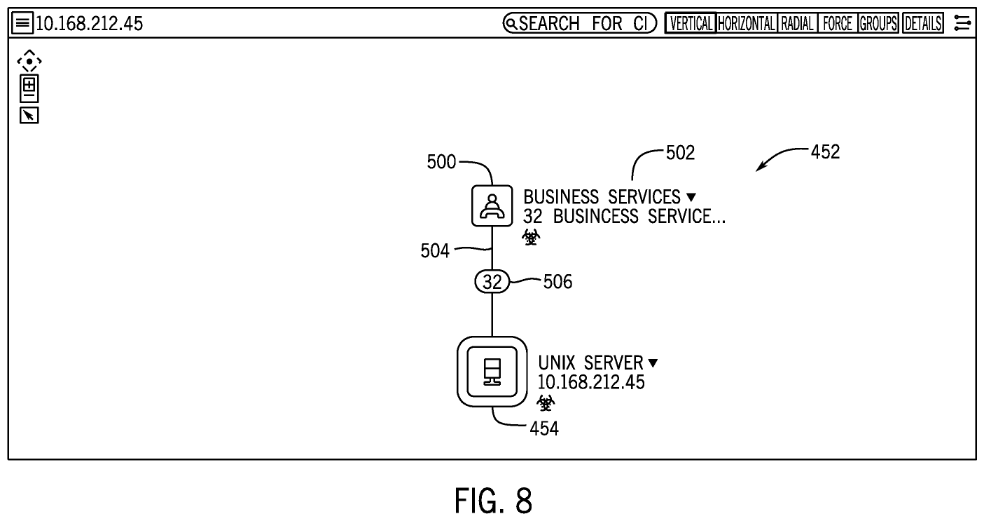

Because the service map 452 for a given network may include many CIs, and each CI may be related to many different services, the service map 452 may include functionality that allows one or more portions of the service map 452 to be expanded and collapsed. For example, FIG. 8 shows the service map 452 of FIG. 7 in collapsed form. As illustrated in FIG. 8, the CIs for the various business services have been combined into a single icon 500 within the service map 452. Accordingly, the caption 502 adjacent to the icon 500 representing the multiple business services indicates that the icon is representative of multiple services. Further, the edge 504 extending between the services icon 500 and the UNIX server 454 CI icon includes a number 506 indicating the number of services that have been collapsed into the single icon.

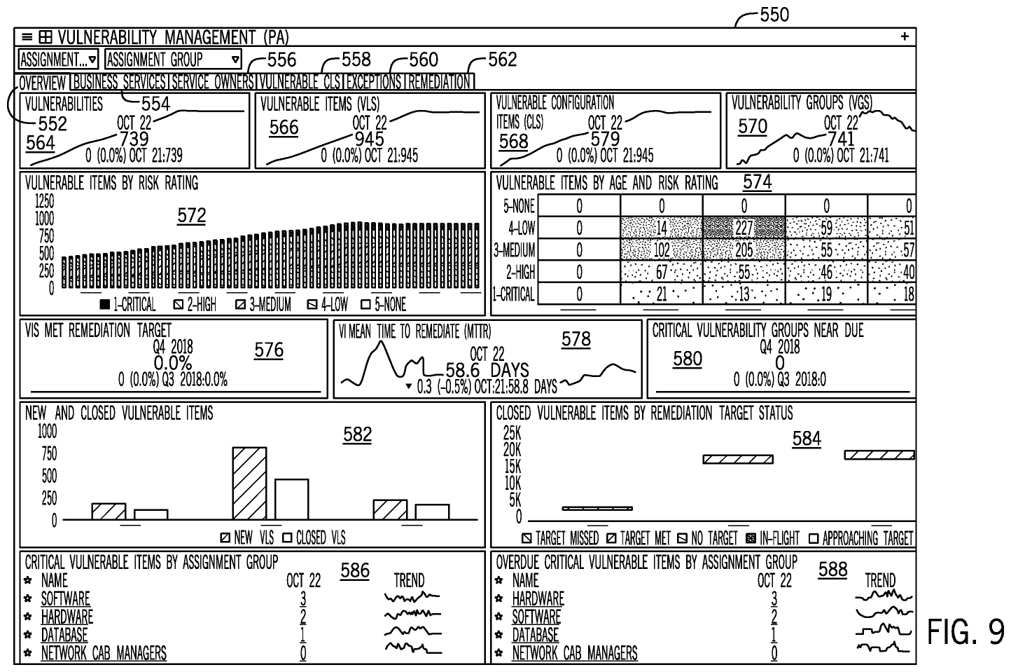

In operating a network, scans and or analysis may be performed to identify network vulnerabilities. Discovered vulnerabilities of a network-connected host may be identified by an IP address of the resource experiencing the vulnerability, which may be associated with a CI. However, it should be understood that other ways to identify resources experiencing vulnerabilities are also envisaged. For example, a vulnerability scanning application may use an agent that is pre-installed on managed devices that will report vulnerability exposure information to a central service. These agents may assign an identifier to a host, which remains constant even if the IP address of the host changes, as in networks using dynamic IP assignment (i.e. DHCP). When a vulnerability is discovered, the service map may be updated to reflect that the resource is experiencing a vulnerability. For example, the appearance of the icon of the CI associated with the resource may change in appearance to indicate that the resource is experiencing the vulnerability. In some embodiments, the icon may be greyed out, change in color, flash, or a colored dot or icon may appear to indicate that a vulnerability has been identified. The discovered vulnerabilities may also be added to a queue to be addressed by an agent or technician. Because it may not be possible to address all vulnerabilities as soon as they are discovered, it may be beneficial to prioritize vulnerabilities or categorize vulnerabilities into groups according to the risk posed to the network. For example, one discovered vulnerability may be fairly innocuous while a second vulnerability may expose the network to substantial risk. Accordingly, even if the second vulnerability is discovered subsequent to the first, it may be beneficial to prioritize the second vulnerability and move it up the queue to be addressed before the first vulnerability. However, it may be difficult to evaluate the risk posed by a given vulnerability based solely on the IP address of the resource or the associated CI. In determining the risk posed by a vulnerability, it may be helpful to consider what the CI experiencing the vulnerability does. For example, what services are associated with the CI experiencing the vulnerability? Accordingly, the relationships between CIs and services used in service mapping may also be used for evaluating the risk posed by a discovered vulnerability. That is, the relationships between CIs and services may be used to determine what services may be affected by the vulnerability. If the importance of each of the various services to a network is known, then the vulnerabilities can be categorized, prioritized, and addressed. With this in mind, a graphical user interface, or series of graphical user interfaces, referred to herein as the Vulnerability Scorecard may be generated for evaluating and prioritizing discovered vulnerabilities. FIGS. 9-18 illustrate various aspects of an embodiment of the Vulnerability Scorecard.

FIG. 9 illustrates a screenshot of the Vulnerability Scorecard 550 when an overview tab 552 is selected. As shown, along the top of the Vulnerability Scorecard 550 is a row of tabs including the overview tab 552, a business services tab 554, a service owners tab 556, a vulnerable CIs tab 558, an exceptions tab 560, and a remediation tab 562. As is described in more detail below, each tab may be configured to show various visual representations of the vulnerabilities experienced by an organization and how those vulnerabilities are being addressed. As shown in FIG. 9, the overview tab may include a plurality of widgets, each shown as a window within the overview tab of the Vulnerability Scorecard 550. Each widget includes one or more visualizations. The widgets may be configurable by a user and may include, for example a vulnerabilities widget 564, a vulnerable items widget 566, a vulnerable CIs widget 568, a vulnerability groups widget 570, a vulnerable items by risk rating widget 572, a vulnerable items by age and risk rating widget 574, a vulnerable items that met remediation target widget 576, a vulnerable items mean time to remediation widget 578, a critical vulnerability groups near due widget 580, a new and closed vulnerable items widget 582, a closed vulnerable items by remediation target status widget 584, a critical vulnerable items by assignment group widget 586, and an overdue critical vulnerable items by assignment group widget 588. It should be understood, however, that the Vulnerability Scorecard 550 shown in FIG. 9 is merely an example and that the particular widgets included in the Vulnerability Scorecard 550 and the order and/or layout of the widgets may be customizable by the user. Accordingly, embodiments of the Vulnerability Scorecard 550 having different widgets and/or widgets in a different layout are also envisaged.

The vulnerabilities widget 564 lists the number of active vulnerabilities, displayed as a single score. In some embodiments, the vulnerabilities widget 564 may also list the current date, the number of active vulnerabilities on a previous date and the change in the number of active vulnerabilities between the previous date and the current date (as a raw value and/or a percentage of the change). The difference in time between the current date and previous date may be set by the user and may include, for example, a day, a work week (i.e., 5 days), a calendar week (i.e., 7 days), two weeks, a month, two months, a quarter, a year, or some other period of time. As shown, the vulnerabilities widget 564 may also include a time series plot of the number of active vulnerabilities over a given time period, set by the user, for example, a day, a work week (i.e., 5 days), a calendar week (i.e., 7 days), two weeks, a month, two months, a quarter, a year, or some other period of time. In some embodiments, the time period of the time series plot may be the same or different than the period of time between the current date and the previous date.

The vulnerable items widget 566 lists the number of active vulnerable items, displayed as a single score. Whereas the vulnerabilities widget 564 displays the number of active vulnerabilities, the vulnerable items widget 566 displays the number of resources that are experiencing the active vulnerabilities or are otherwise affected by the active vulnerabilities. As with the vulnerabilities widget 564, the vulnerable items widget 566 may display the current date, the number of active vulnerable items on a previous date and the change in the number of active vulnerable items between the previous date and the current date (as a raw value and/or a percentage of the change). The difference between the current date and previous date may be set by the user and may include, for example a day, a work week (i.e., 5 days), a calendar week (i.e., 7 days), two weeks, a month, two months, a quarter, a year, or some other period of time. The vulnerable items widget 566 may also include a time series plot of the number of resources that are experiencing the active vulnerabilities or are otherwise affected by the active vulnerabilities over a given time period, set by the user, which may be the same or different than the period of time between the current date and the previous date.

The vulnerable CIs widget 568 lists the number of active vulnerable configuration items that are experiencing the active vulnerabilities or are otherwise affected by the active vulnerabilities, displayed as a single score. As with the vulnerabilities widget 564 and the vulnerable items widget 566, the vulnerable CIs widget 568 may display the current date, the number of active vulnerable CIs on a previous date and the change in the number of active vulnerable CIs between the previous date and the current date (as a raw value and/or a percentage of the change). The difference between the current date and previous date may be set by the user. The vulnerable CIs widget 568 may also include a time series plot of the number of active vulnerable configuration items that are experiencing the active vulnerabilities or are otherwise affected by the active vulnerabilities over a given time period, set by the user, which may be the same or different than the period of time between the current date and the previous date.

The vulnerability groups widget 570 lists the number of active vulnerability groups that are experiencing the active vulnerabilities or are otherwise affected by the active vulnerabilities, displayed as a single score. As with the vulnerabilities widget 564, the vulnerable items widget 566, and the vulnerable CIs widget 568, the vulnerability groups widget 570 may display the current date, the number of active vulnerability groups on a previous date and the change in the number of vulnerability groups between the previous date and the current date (as a raw value and/or a percentage of the change). The difference between the current date and previous date may be set by the user. The vulnerability groups widget 570 may also include a time series plot of the number of active vulnerability groups that are experiencing the active vulnerabilities or are otherwise affected by the active vulnerabilities over a given time period, set by the user, which may be the same or different than the period of time between the current date and the previous date.

The vulnerable items by risk rating widget 572 displays the number of active vulnerable items by risk tier, which can combine the severity of the vulnerability in isolation, criticality of the affected asset, and exploit availability as a time series bar chart. As shown, the vulnerable items by risk rating widget 572 displays a bar for each day. The height of the bar for each day reflects the total number of active vulnerable items for that day. The bar is then divided into portions, the height of each portion corresponding to the number of vulnerable items of the total number of vulnerable items for that day that fall into a respective category. For example, in the embodiment shown in FIG. 9, the categories reflect varying degrees of risk of the vulnerability (e.g., critical, high, medium, low, none). However, it should be understood that other categories may also be used.

The vulnerable items by age and risk rating widget 574 displays the number of vulnerable items by risk rating and how long they have been prevalent on the network as a heatmap. As shown in FIG. 9, the heatmap includes a grid having two axes. The vertical axis corresponds to vulnerability severity category. The horizontal axis corresponds to the age of the vulnerability in days. Each vulnerable item is given a risk rating and has an associated age based upon when the underlying vulnerability arose or was discovered. Based on the risk rating and the associated age, each vulnerable item is assigned to a box in the grid. The number in each box of the grid corresponds to the number of vulnerable items assigned to that box. In some embodiments, the color of each box may correspond to the number of vulnerable items assigned to that box. For example, as the number of vulnerable items associated with a box in the grid increases, the color of that box transitions from a lighter end of the color spectrum to a darker end of the color spectrum. It should be understood, however, that the heat map may be configured such that the horizontal and/or vertical axes correspond to different qualities of a vulnerable item. Similarly, heat maps may be generated by other widgets for metrics other than vulnerable items. For example, similar heat maps may be generated for vulnerabilities, vulnerable configuration items, vulnerable groups, and so forth.

The vulnerable items met remediation target widget 576 displays the percentage of vulnerable items that were resolved before their remediation target (i.e. service level agreement) within the current period, displayed as a single score. In some embodiments, the criticality of a vulnerable item, as influenced by the associated business service, may determine which service level is applied. The vulnerable items met remediation target widget 576 may display the current period (e.g., quarter, week, month, year, etc.), the number of vulnerable items that met their remediation target in the previous period and the change in the number of vulnerable items that met their remediation target between the previous period and the current period (as a raw value and/or a percentage of the change). The length of each period may be set by the user.

The vulnerable items mean time to remediation widget 578 displays the mean time to remediate a typical vulnerable item, from discovery or development of the vulnerability to resolution, displayed as a single score. The vulnerable items mean time to remediation widget 578 may display the current date, the mean time to remediation on a previous date and the change in the mean time to remediation between the previous date and the current date (as a raw value and/or a percentage of the change). In some embodiments, the change in the value may be displayed with an arrow and/or in color to indicate whether the value is increasing or decreasing. The difference between the current date and previous date may be set by the user. In some embodiments, the Vulnerability Scorecard 550 may also display whether a goal for the particular value has been met. The vulnerable items mean time to remediation widget 578 may also include a time series plot of the mean time to remediation over a given time period, set by the user, which may be the same or different than the period of time between the current date and the previous date.

The critical vulnerability groups near due widget 580 displays the number of active vulnerability groups that are close to their due date, displayed as a single score. The due date is based on the earliest remediation target date across all active vulnerable items within the group, which in turn can be defined by the criticality of affected business services. As with the vulnerable items met remediation target widget 576, the critical vulnerability groups near due widget 580 may display the current period (e.g., quarter, week, month, year, etc.), the number of critical vulnerability groups near due in the previous period and the change in the number of critical vulnerability groups near due between the previous period and the current period (as a raw value and/or a percentage of the change). The length of each period may be set by the user.

The new and closed vulnerable items widget 582 displays the number of vulnerable items that have been newly discovered compared with the number that have been remediated, by month as a bar chart. As shown, for each month, the number of newly discovered vulnerable items are shown as a first bar and the number of vulnerable items remediated within the month are shown as a second bar.

The closed vulnerable items by remediation target status widget 584 displays the number of remediated vulnerable items that have met or missed their remediation target date, as defined by the criticality of affected business services, or had no remediation target date, as a time series bar chart. For example, the closed vulnerable items by remediation target status widget 584 displays, for each month, the number of remediated or closed vulnerable items that, at the time of closure, had (1) missed their target, (2) met their target, (3) had no target, (4) were in flight, or (5) were approaching their target.

The critical vulnerable items by assignment group widget 586 displays the number of active vulnerable items with a “critical” risk rating, as influenced by the criticality of affected business services, grouped by remediation team, with a trend graph. For example, in the embodiment shown in FIG. 9, the remediation teams include a software team, a hardware team, a database team, and a network CAB managers team. For each team, the critical vulnerable items by assignment group widget 586 displays the number of active critical vulnerable items on the current date, as well as a time series graph of the number of active critical vulnerable items for each day in a set period of time.

The overdue critical vulnerable items by assignment group widget 588 displays the number of active vulnerable items with a “critical” risk rating that are past their remediation target dates grouped by remediation team, with a trend graph. As shown, the remediation teams are the same as those listed in the critical vulnerable items by assignment group widget 586. Similarly, for each team, the overdue critical vulnerable items by assignment group widget 588 displays the number of active and overdue critical vulnerable items on the current date, as well as a time series graph of the number of active overdue critical vulnerable items for each day in a set period of time.

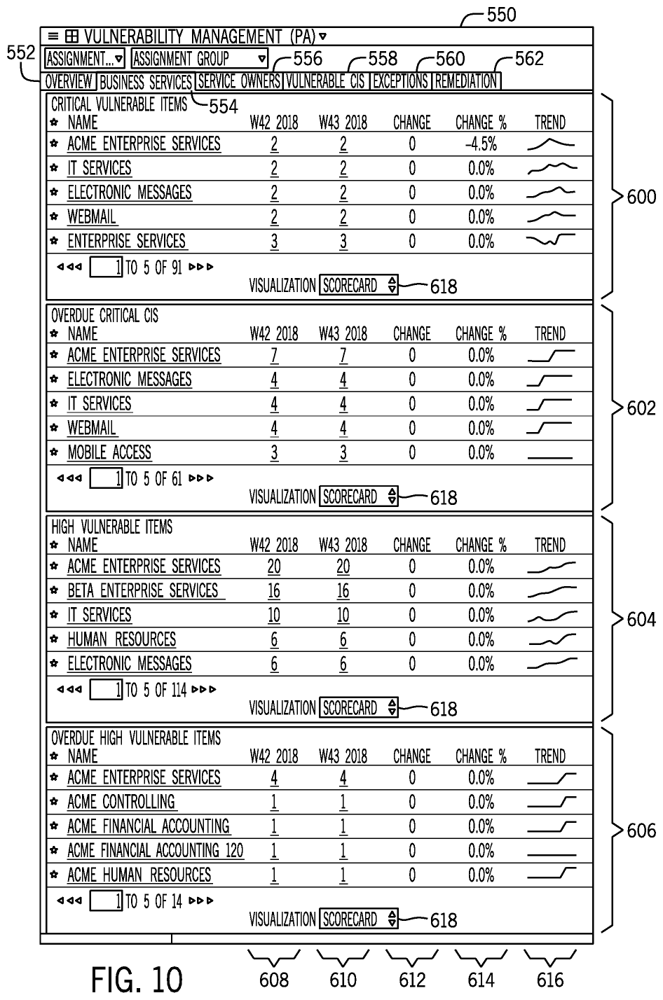

FIG. 10 illustrates a screenshot of the Vulnerability Scorecard 550 when the business services tab 554 is selected. As illustrated, when the business services tab 554 is selected, the Vulnerability Scorecard 550 displays the business services experiencing vulnerabilities, categorized into various groups. These groups may include, for example, (1) critical vulnerable items 600, (2) overdue critical vulnerable items 602, (3) high vulnerable items 604, and (4) overdue high vulnerable items 606. The critical vulnerable items 600 listing includes the business services with the largest number of active vulnerable items that have a “critical” risk rating. The overdue critical vulnerable items 602 listing includes the business services with the largest number of active vulnerable items that have a “critical” risk rating and are past their remediation target date. The high vulnerable items 604 listing includes the business services with the largest number of active vulnerable items that have a “high” risk rating. The overdue high vulnerable items 606 listing includes the business services with the largest number of active vulnerable items that have a “critical” risk rating and are past their remediation target date. For each business service listed in each category, the Vulnerability Scorecard 550 displays the number of qualifying vulnerable items in the previous period 608 (e.g., day, week, month, quarter, year, etc.), the number of qualifying vulnerable items in the current period 610, the raw number of change in vulnerable items between the previous period and the current period 612, the percentage change in vulnerable items between the previous period and the current period 614, and a trend line 616.

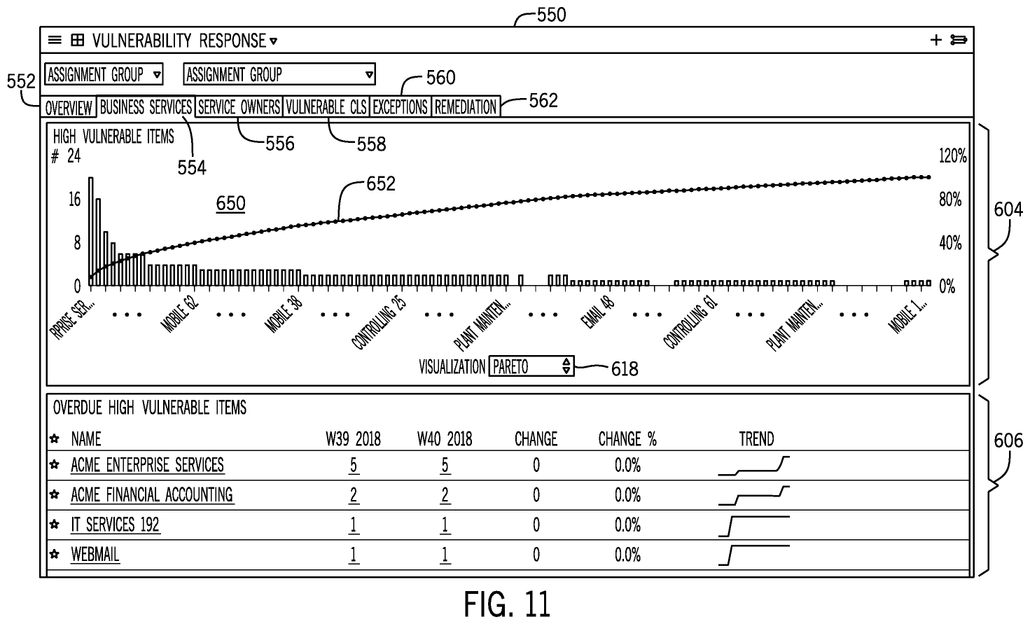

As illustrated in FIG. 10, each group 600, 602, 602, 604, 606 includes a drop down menu 618 that allows the user to toggle the Vulnerability Scorecard 550 between various available visualizations. In the embodiment shown in FIG. 10, the business services are shown in a list according to a “scorecard” visualization. However, the drop-down menu may be used to select other types of visualizations (e.g., pie, donut, semi-donut, funnel, pyramid, column, Pareto, line, columns and total, stacked column, relative compare, treemap, etc.). For example, FIG. 11 illustrates an embodiment of the Vulnerability Scorecard 550 with the business services tab 554 selected and in which the “High Vulnerable Items” group 604 is displayed according to a Pareto visualization 650. As shown, the various business services are ordered from left to right based on the number of active high vulnerability items, with the business services having the highest number of active high vulnerability items on the left. A bar is generated for each business service, the height of which corresponds to the number of active high vulnerability items for the business service. Further, a line 652 represents the percentage of the total number of active high vulnerability items accounted for as one moves from left to right.

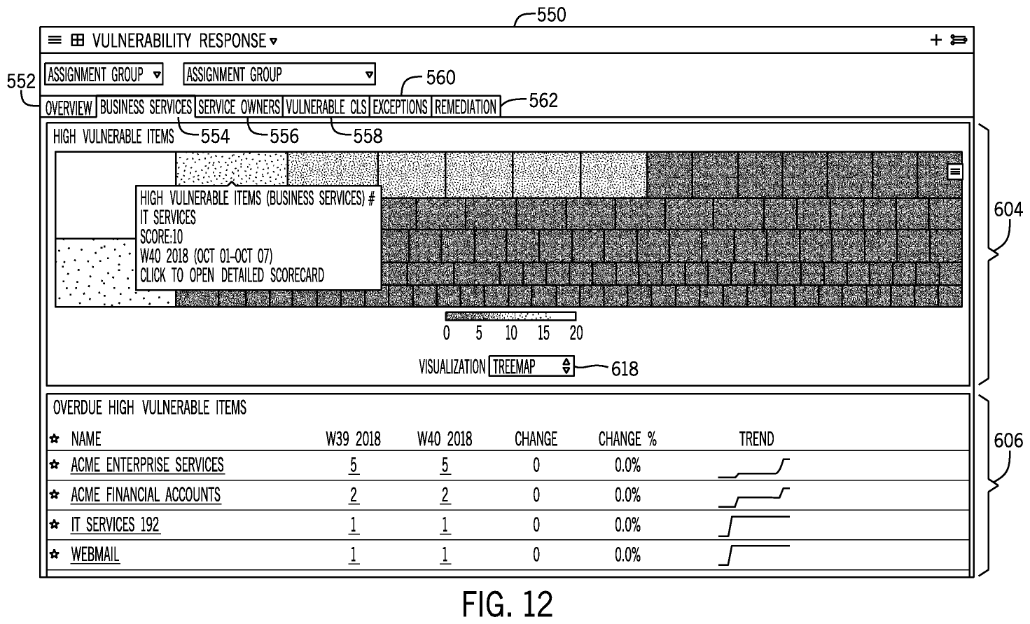

Similarly, FIG. 12 illustrates an embodiment of the Vulnerability Scorecard 550 with the business services tab 554 selected and in which the “High Vulnerable Items” group 604 is displayed according to a treemap visualization. Treemap visualizations are particularly good at producing visualizations of hierarchical data. Accordingly, a treemap visualization may be good for identifying vulnerable items that affect many resources and/or services (e.g., networks in which there are many dependencies between services and/or resources. Accordingly, the treemap visualization may be useful in identifying the services and/or resources most affected by vulnerabilities and/or the vulnerabilities that affect the greatest number of services and/or resources. As shown, the user may select or mouse over blocks of the treemap visualization to see more information about what that block represents. In the instant embodiment, the blocks represent services, wherein the size of the block corresponds to the number of vulnerabilities affecting the services. In the instant embodiment, a business service called “IT Services” is affected by the third largest number of high vulnerability items, as the corresponding box is the third largest box in the visualization. Further, the number of high vulnerability items affecting a service may be represented by the color or gradient of the corresponding box.

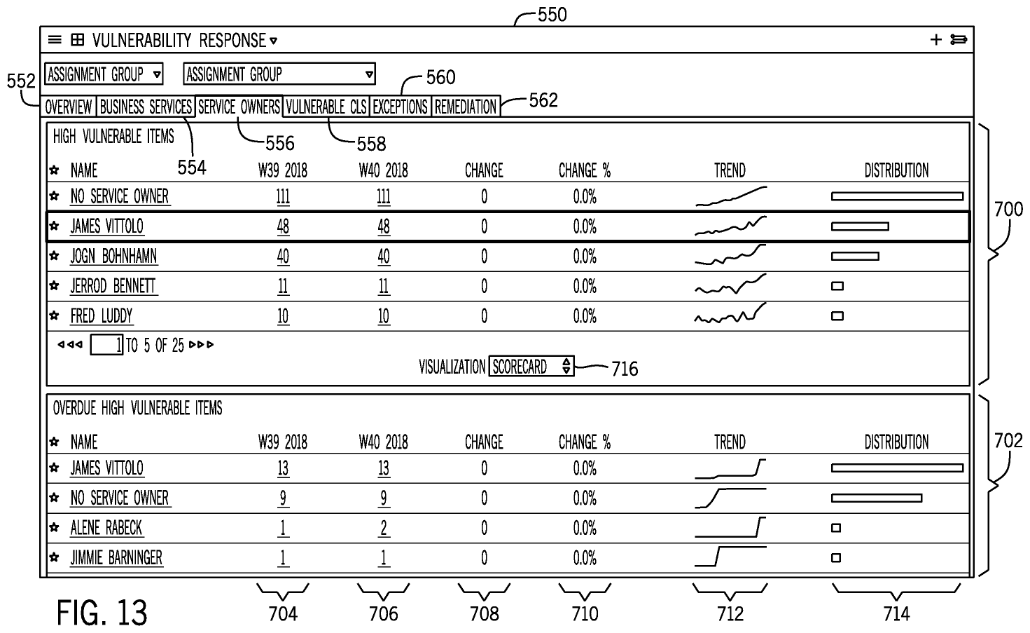

FIG. 13 illustrates an embodiment of the Vulnerability Scorecard 550 with the service owners tab 556 selected. Each business service is associated with an “owner”, an individual who is responsible for a business service and assumes the business risk of affecting vulnerabilities. As shown, the Vulnerability Scorecard 550 groups the owners into owners of business services experiencing high vulnerable items 700, and owners of business services experiencing overdue high vulnerable items 702. As shown in FIG. 13, an owner may be responsible for a business services or business services that is experiencing both high vulnerable items and overdue high vulnerable items may appear in both groups. For each owner listed in each category, the Vulnerability Scorecard 550 displays the number of qualifying vulnerable items experienced by a business service for which the owner is responsible in the previous period 704 (e.g., day, week, month, quarter, year, etc.), the number of qualifying vulnerable items experienced by a business service for which the owner is responsible in the current period 706, the raw number of change in vulnerable items between the previous period and the current period 708, the percentage change in vulnerable items between the previous period and the current period 710, a trend line 712, and a distribution of vulnerable items experienced by a business service owned by the particular owner. As with the business services tab 554 discussed with regard to FIGS. 10-12, the Vulnerability Scorecard 550 shown in FIG. 13 displays owners of business services experiencing various categories of vulnerable items in a scorecard view. However, each grouping of owners includes a drop-down menu 716 by which a user may toggle the Vulnerability Scorecard 550 to a different style of visualization (e.g., pie, donut, semi-donut, funnel, pyramid, column, Pareto, line, columns and total, stacked column, relative compare, treemap, etc.).

By utilizing the service owners tab 556, managers can see which service owners are sufficiently and timely addressing vulnerabilities, and which service owners are not. Based on this information, the managers can adjust the allocation of resources (e.g., move IT operations personnel that can remediate vulnerabilities to the business services of need), follow up with business service owners about their performance, and/or utilize incentives, rewards, and/or penalties to improve performance. Further, the service owners tab 556 may be utilized by service owners to better understand the scope and composition of their scanned CIs, which technologies need the most attention, and identify decommissioned assets with vulnerable items and close them as irrelevant. Further, the service owners tab 556 may be utilized to identify the number of vulnerable CIs that lack ownership information, so that owners can be assigned to these assets before a critical vulnerability arises.

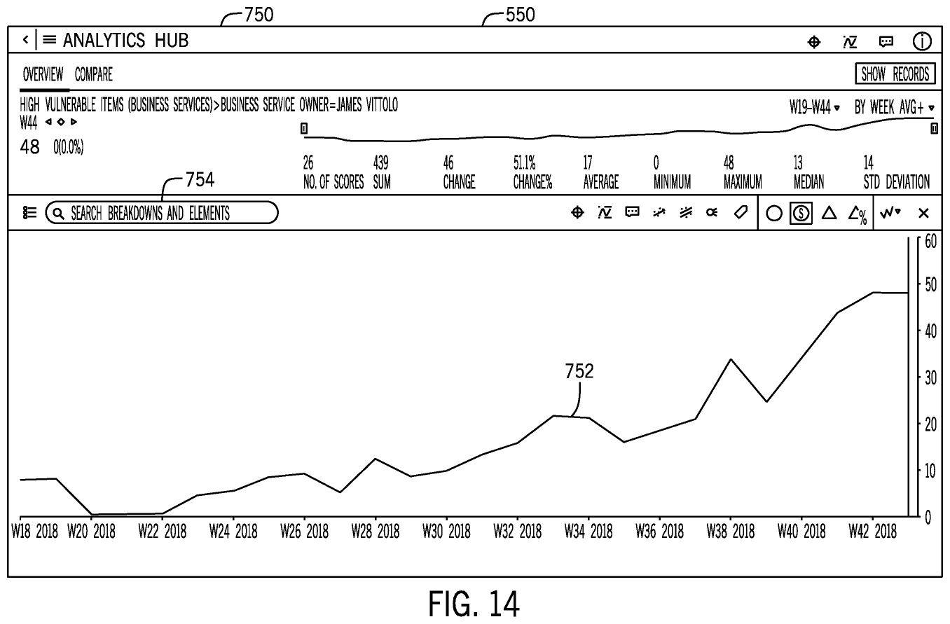

Within the service owners tab 556, service owners may be selected in order to display more information about the selected service owner's performance. FIG. 13 shows that a service owner named “James Vittolo” has been selected within the “High Vulnerable Items” scorecard 700. Upon selection of an owner, an analytics hub window 750 opens, shown in FIG. 14, displaying information about business services in the “High Vulnerable Items” group that are owned by James Vittolo. As shown, the analytics hub window 750 may include a trend line 752 plotting the raw number of vulnerable items with a “high” risk rating experienced by one or more business services owned by the selected owner from week to week, and a number of metrics for the data over this timeframe. The analytics hub window 750 of FIG. 14 includes a “search breakdowns and elements” box 754 that allows data plotted in the main graph window to be broken down by various categories.

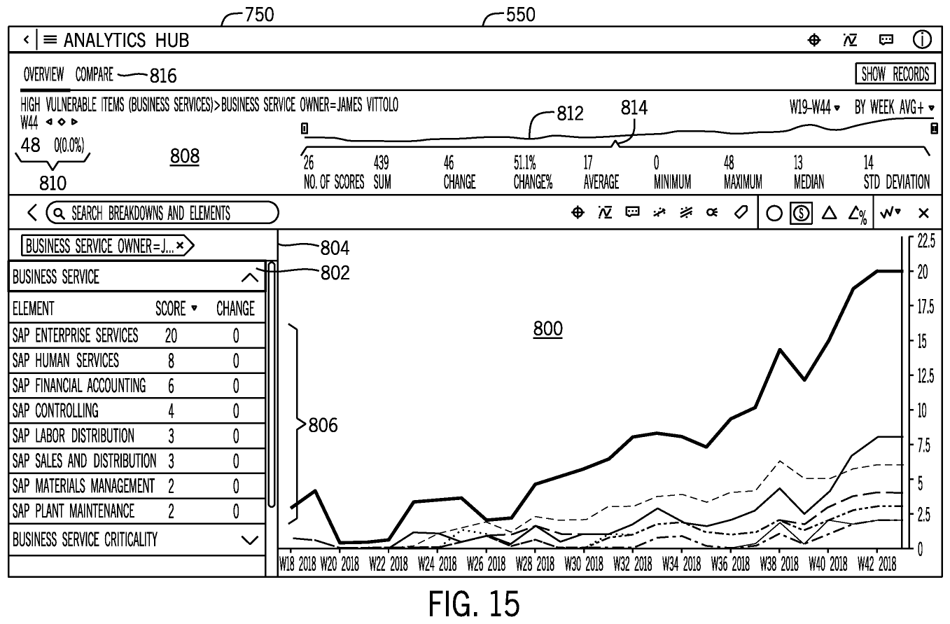

FIG. 15 illustrates the analytics hub window 750 displaying a plot 800 of the number of vulnerabilities in the “High Vulnerable Items” group experienced by business services that are owned by James Vittolo, broken down by business service, in which each line represents a respective business service. The presence of the business service breakdown banner 802 in the breakdowns window 804 indicates that “business service” has been selected from a menu of available breakdown options. As such, the breakdowns window 804 displays a listing 806 of business services that are owned by James Vittolo and experiencing high vulnerable items. For each service, the listing 806 includes a score indicative of the number of high vulnerable items experienced by that service and a value indicative of the change in the score between the previous period and the current period.

The analytics hub window 750 also includes a summary window 808, which may include, for example, a listing 810 of the total number of active high vulnerable items experienced by business services owned by James Vittolo, as well as the change in the total number of active high vulnerable items experienced by business services owned by James Vittolo between the previous period and current period, expressed as both a raw score and a percentage. The summary window 808 may also include a trendline 812 tracking the number of active high vulnerable items experienced by business services owned by James Vittolo over a set window of time, and statistics 814 associated with the number of active high vulnerable items experienced by business services owned by James Vittolo over the set window of time, such as number of scores, sum, raw change, percent change, average, minimum, maximum, median, and standard deviation. In some embodiments, the analytics hub 750 may also include a compare tab 816 that allows comparison between two or more owners.

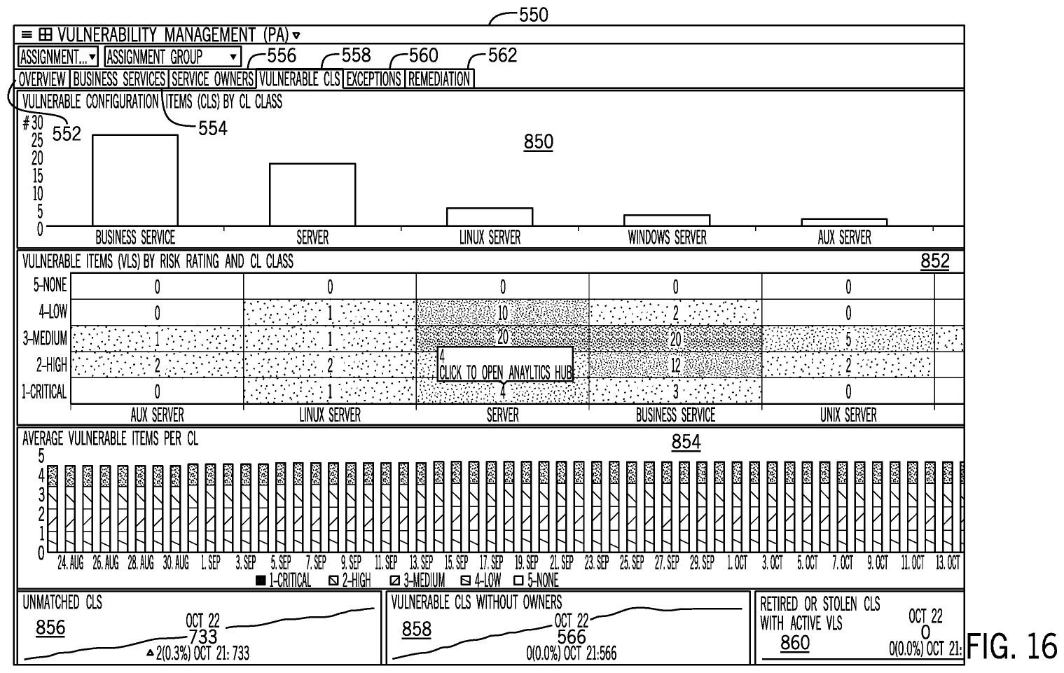

FIG. 16 illustrates the Vulnerability Scorecard 550 when the Vulnerable CIs tab 558 is selected. As illustrated, the Vulnerability Scorecard 550 includes multiple widgets for displaying various visualizations for vulnerable CIs. As shown in FIG. 16, the widgets may include a vulnerable CIs by CI class widget 850, a vulnerable items (VIs) by risk rating and CI class widget 852, an average vulnerable items per CI widget 854, an unmatched CIs widget 856, a vulnerable CIs without owners widget 858, and a retired or stolen CIs with active VIs widget 860.

The vulnerable CIs by CI class widget 850 displays the number CIs with active vulnerabilities in each of multiple CI classes, from most to least in a bar chart. As shown, the widget 850 includes a bar for each CI class. The height of each bar corresponds to the number of CIs experiencing active vulnerabilities in the respective class.

The vulnerable items (VIs) by risk rating and CI class widget 852 displays the number of active vulnerable items by risk rating and CI class in a heatmap. As with the heat map described with regard to the vulnerable items by age and risk rating widget in FIG. 9, the vulnerable items (VIs) by risk rating and CI class widget 852 heat map includes a vertical axis and a horizontal axis. The value for each box in the grid corresponds to the values of the vertical and horizontal axes. In some embodiments, each box may be shaded in a color or gradient that corresponds to the value of the box.

The average vulnerable items per CI widget 854 displays the average number of active vulnerable items belonging to a CI, grouped by risk rating, in a time series bar chart. As shown, each date is given a bar representing the average number of vulnerable items per CI. Each bar is broken up into sections corresponding to categories of vulnerable items such that the length of each section corresponds to the average number of vulnerable items per CI that fall into the corresponding category.

The unmatched CIs widget 856 displays the number of imported CIs that did not match an existing CI in the CMDB and may need to be re-classified, as a single score. In some embodiments, the unmatched CIs widget 856 may also display the current date or time period, the number of unmatched CIs in the previous date or time period, and a change between the previous period and the current period (as a raw number and a percentage change). In some embodiments, the unmatched CIs widget 856 may also include an arrow and/or use color coding (e.g., red, green, yellow) to indicate whether the number is increasing, decreasing, or staying the same. The unmatched CIs widget 856 may also include a trendline that plots the number of unmatched CIs over a period of time.

The vulnerable CIs without owners widget 858 displays the number of vulnerable CIs that do not have an assigned owner or other support group for maintenance activities. As with the unmatched CIs widget 856, the vulnerable CIs without owners widget 858 may display the current date or time period, the number of vulnerable CIs without owners in the previous date or time period, and a change between the previous period and the current period (as a raw number and a percentage change). In some embodiments, the vulnerable CIs without owners widget 858 may also include an arrow and/or use color coding (e.g., red, green, yellow) to indicate whether the number is increasing, decreasing, or staying the same. The vulnerable CIs without owners widget 858 may also include a trendline that plots the number of vulnerable CIs that do not have an assigned owner over a period of time.

The retired or stolen CIs with active VIs widget 860 displays the number of CIs marked Retired or Stolen in the CMDB that have active vulnerable items. As with the unmatched CIs widget 856 and the vulnerable CIs without owners widget 858, the retired or stolen CIs with active VIs widget 860 may display the current date or time period, the number of retired or stolen CIs with active VIs in the previous date or time period, and a change between the previous period and the current period (as a raw number and a percentage change). In some embodiments, the CIs widget 860 may also include an arrow and/or use color coding (e.g., red, green, yellow) to indicate whether the number is increasing, decreasing, or staying the same. The retired or stolen CIs with active VIs widget 860 may also include a trendline that plots the number of retired or stolen CIs with active VIs over time.

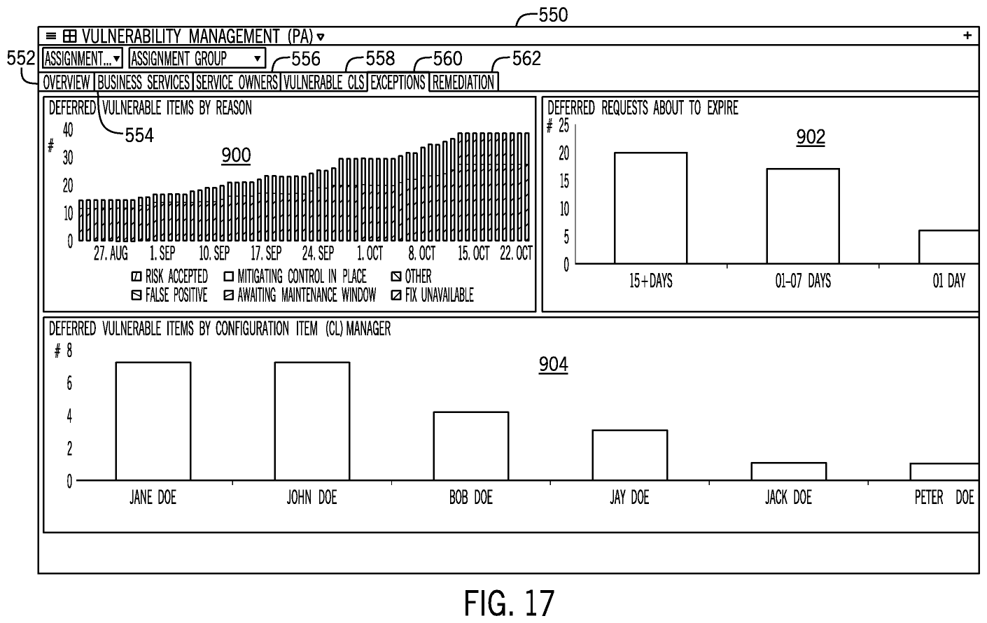

FIG. 17 illustrates the Vulnerability Scorecard 550 when the exceptions tab 560 has been selected. The exceptions tab 560 may display information for identified vulnerabilities for which there are no immediate plans to take remedial action, often determined by the owner of affected business services. For example, an identified vulnerability may have been a false positive, the risk associated with the vulnerability may be accepted because remediation activities would be too expensive, measures may have been put in place to mitigate the risk, remedial action may be unknown or unavailable, the identified vulnerability may be awaiting maintenance, etc. As illustrated, when the exceptions tab 560 is selected, the Vulnerability Scorecard 550 may display a deferred vulnerable items by reason widget 900, a deferral requests about to expire widget 902, and a deferred vulnerable items by configuration item (CI) manager widget 904.

The deferred vulnerable items by reason widget 900 displays the number of deferred vulnerable items organized by deferral reason, in a time series bar chart. As shown, each day (or other period of time, such as week, month, quarter, year, etc.) is represented by a bar. The length of each bar corresponds to the number of deferred vulnerable items during that period of time. The bar is then broken up into one or more colored sections, where the length of each section corresponds to the number of deferred vulnerable items during that period of time that were deferred for a particular reason. As shown in FIG. 17, the various reasons for deferment may include, for example, risk accepted, false positive, mitigating control in place, awaiting maintenance window, fix unavailable, other, etc.

The deferral requests about to expire widget 902 displays the number of deferred vulnerable items, for which the deferral request is about to expire, in a bar chart. For example, as shown in FIG. 17, the deferral requests about to expire widget 902 groups deferral requests for vulnerable items into groups based on ranges of value for when the deferral request expires (e.g., 1 day, 2-7 days, 8-14 days, 15 or more days, etc.). The deferral requests about to expire widget 902 displays a bar for each group, in which the length of the bar represents the number of deferral requests in the respective group at the time the widget was last updated.

The deferred vulnerable items by configuration item (CI) manager widget 904 displays the number of deferred vulnerable items grouped by the manager of the associated CI (i.e. the owner or submitter of the deferral request), in a bar chart. As shown in FIG. 17, the deferred vulnerable items by configuration item (CI) manager widget 904 displays a bar for each CI manager, in which the length of the bar represents the number of deferred vulnerable items under the respective CI manager at the time the widget was last updated.

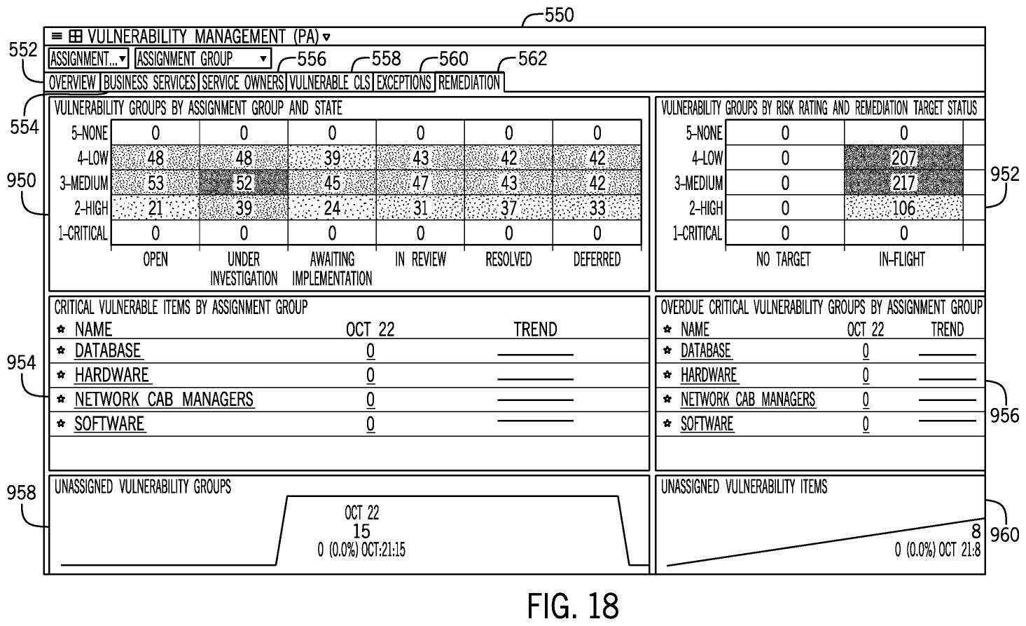

FIG. 18 illustrates the Vulnerability Scorecard 550 when the remediation tab 562 has been selected. The remediation tab 562 may display information for plans to take remedial action for identified vulnerabilities. As illustrated, when the remediation tab 562 is selected, the Vulnerability Scorecard 550 may display a vulnerability groups by assignment group and state widget 950, a vulnerability groups by risk rating and remediation target status widget 952, a critical vulnerability groups by assignment group widget 954, an overdue critical vulnerability groups by assignment group widget 956, an unassigned vulnerability groups widget 958, and an unassigned vulnerable items widget 960.

The vulnerability groups by assignment group and state widget 950 displays the number of active vulnerability groups (i.e. vulnerability groups with one or more active vulnerable items) by risk rating and remediation state in a heat map. As shown, the heatmap includes a grid having two axes. The vertical axis corresponds to risk rating. The horizontal axis corresponds to remediation state. Each vulnerability group is given a risk rating (e.g., none, low, medium, high, critical, etc.) and a remediation state (e.g., open, under investigation, awaiting implementation, in review, resolved, deferred, etc.). Based on the risk rating and the remediation state, each vulnerability group is assigned to a box in the grid. The number in each box of the grid corresponds to the number of vulnerability groups assigned to that box. In some embodiments, the color of each box may correspond to the number of vulnerability groups assigned to that box. For example, as the number of vulnerability groups associated with a box in the grid increases, the color of that box transitions from a lighter end of the color spectrum to a darker end of the color spectrum. It should be understood, however, that the heat map may be configured such that the horizontal and/or vertical axes correspond to different qualities of a vulnerability group.

The vulnerability groups by risk rating and remediation target status widget 952 displays the number of active vulnerability groups by risk rating and remediation target status (ex. near due, past due), in a heatmap. As with the heat map of the vulnerability groups by assignment group and state widget 950, the heatmap of the vulnerability groups by risk rating and remediation target status widget 952 has two axes. The vertical axis corresponds to risk rating. The horizontal axis corresponds to target status. Each vulnerability group is given a risk rating (e.g., none, low, medium, high, critical, etc.) and a target state (e.g., no target, in flight, etc.). Based on the risk rating and the target state, each vulnerability group is assigned to a box in the grid. The number in each box of the grid corresponds to the number of vulnerability groups assigned to that box. In some embodiments, the color of each box may correspond to the number of vulnerability groups assigned to that box. For example, as the number of vulnerability groups associated with a box in the grid increases, the color of that box transitions from a lighter end of the color spectrum to a darker end of the color spectrum.

The critical vulnerability groups by assignment group widget 954 lists the number of active non-deferred vulnerability groups with a critical risk rating grouped by remediation team. As shown, the assignment groups are listed vertically. The number of critical vulnerability groups assigned to each assignment group on one or more days (or other periods of time, such as weeks, months, quarters, years, etc.) are listed. In some embodiments, the critical vulnerability groups by assignment group widget 954 may also display a trend line for each assignment group, which may include a time series plot that displays how the value has changed over a specified period of time. In some embodiments, rather than a time series plot, the critical vulnerability groups by assignment group widget 954 may display a change in the number of critical vulnerability groups for each assignment group between the previous period and the current period. The change may be displayed by a raw score and/or a percent change. In some embodiments, the critical vulnerability groups by assignment group widget 954 may also display an arrow and/or color code the change to indicate whether the change in the number of critical vulnerability groups for each assignment group increased or decreased between the previous period and the current period.

The overdue critical vulnerability groups by assignment group widget 956 lists the number of active non-deferred vulnerability groups with a critical risk rating that are past their remediation target date grouped by assignment group. As with the critical vulnerability groups by assignment group widget 954, the overdue critical vulnerability groups by assignment group widget 956 lists assignment groups vertically. The number of overdue critical vulnerability groups assigned to each assignment group on one or more days (or other periods of time, such as weeks, months, quarters, years, etc.) are listed. In some embodiments, the overdue critical vulnerability groups by assignment group widget 956 displays a trend line for each assignment group, which may include a time series plot that displays how the value has changed over a specified period of time. In some embodiments, rather than a time series plot, the overdue critical vulnerability groups by assignment group widget 956 may display a change in the number of overdue critical vulnerability groups for each assignment group between the previous period and the current period. The change may be displayed by a raw score and/or a percent change and may also include an arrow and/or color code the change to indicate whether the change in the number of overdue critical vulnerability groups for each assignment group increased or decreased between the previous period and the current period.

The unassigned vulnerability groups widget 958 displays the number of unassigned active vulnerability groups, in a single score. The unassigned vulnerability groups widget 958 may display the current date, the number of unassigned active vulnerability groups on a previous date and the change in the number of unassigned active vulnerability groups between the previous date and the current date (as a raw value and/or a percentage of the change). In some embodiments, the change in the value may be displayed with an arrow and/or in color to indicate whether the value is increasing or decreasing. The difference between the current date and previous date may be set by the user. The unassigned vulnerability groups widget 958 may also include a time series plot of the number of unassigned active vulnerability groups over a given time period, set by the user, which may be the same or different than the period of time between the current date and the previous date.

The unassigned vulnerable items widget 960 displays the number of unassigned active vulnerable items, in a single score. The unassigned vulnerable items widget 960 may display the current date, the number of unassigned vulnerable items on a previous date and the change in the number of unassigned vulnerable items between the previous date and the current date (as a raw value and/or a percentage of the change). In some embodiments, the change in the value may be displayed with an arrow and/or in color to indicate whether the value is increasing or decreasing. The difference between the current date and previous date may be set by the user. The unassigned vulnerable items widget 960 may also include a time series plot of the number of unassigned vulnerable items over a given time period, set by the user, which may be the same or different than the period of time between the current date and the previous date.

Though not illustrated in FIGS. 9-18, embodiments of the vulnerability scorecard 550 are envisaged in which widgets meeting some condition (open number of vulnerabilities, number of old vulnerabilities, etc.) appear in a distinctive color, bold, blink, or are otherwise emphasized. Further, embodiments are also envisaged in which thresholds may be set for one or more metrics (age of an identified vulnerability, age of an identified vulnerability within one or more selected classes, number of unresolved vulnerabilities, number of unresolved vulnerabilities within one or more selected classes, a specific service encounters a vulnerability, a service owner reaches a threshold number of vulnerabilities, a service owner reaches a threshold number of vulnerabilities older than a set age, etc.). When the threshold or thresholds are met, a notification, email, or report may be generated and sent to the service owner, a technician, or their supervisor. Along these lines, it should be understood that the vulnerability scorecard 550 may be customizable by a user such that a customized version of the vulnerability scorecard 550 may differ from embodiments disclosed herein. For example, a user may customize the widgets included in the vulnerability scorecard 550 and/or the order in which the widgets appear. Accordingly, embodiments of the vulnerability scorecard 550 are envisaged that omit one or more of the disclosed widgets and/or include one or more additional widgets. Further, individual widgets may be customizable by a user to include threshold floors and/or ceilings, cover different periods of time, track different metrics, display differently, and so forth. As such, it should be understood that the various embodiments of the vulnerability scorecard 550 shown in FIGS. 9-18 are merely examples and that other embodiments of the vulnerability scorecard 550 are also envisaged.

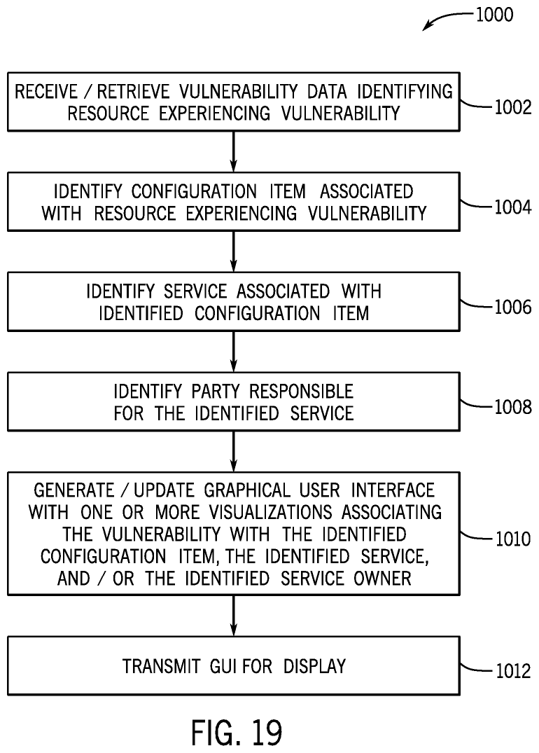

FIG. 19 is a flow chart of a process 1000 for receiving vulnerability data, processing the vulnerability data, and populating a GUI (e.g., a vulnerability scorecard) based on the vulnerability data. At block 1002, vulnerability is received or retrieved. The vulnerability data may identify one or more network vulnerabilities experienced by a resource (e.g., hardware component, software component, etc.) of a computing network. The vulnerability data may identify the resource experiencing the vulnerability, for example, by an internet protocol (IP) address, or some other identifying alphanumeric character string.

At block 1004, for each resource experiencing a vulnerability, an associated CI is identified from a CMDB. For example, the CMDB may include a listing for each configuration item, which corresponds to a respective resource. The listing for each CI may include a number of fields which may identify aspects or characteristics of the CI. The listing for some CIs may include, for example, an IP address, serial number, model number, given name/code, or some other alphanumeric character string that may be used to identify a resource and associated the resource with a CI. Accordingly, if the received/retrieved vulnerability data includes an IP address (or other alphanumeric character string) identifying the resource experiencing the vulnerability, the CMDB may be cross-checked to identify the CI associated with the resource experiencing the vulnerability.

At block 1006, for each resource experiencing a vulnerability, one or more services are identified that are associated with the identified CI. The identified CI may be used to perform or provide the identified service. For example, the service may include purchasing, procurement, IT services, email, human resources, accounting, payment processing, inventory, maintenance, and so forth. Data linking services to CIs may be stored, for example in the CMDB or in some other database. Accordingly, once the CIs associated with the resources experiencing the vulnerabilities have been identified, the relationship data may be cross-checked to identify the services affected by the vulnerabilities.

At block 1008, for each resource experiencing a vulnerability, one or more parties responsible for the one or more identified services are identified. Data identifying responsible parties (e.g., one or more individuals) for various services performed or offered may be stored, for example in the CMDB or in some other database. Accordingly, services affected by the vulnerability have been identified, the responsible party data may be cross-checked to identify the responsible parties for the services affected by the vulnerabilities.

At block 1010, a GUI (e.g., the vulnerability scorecard shown in FIGS. 9-18) is generated or updated based on the received vulnerability data and the identified CIs, services, and responsible parties. As shown and described with regard to FIGS. 9-18, the GUI may include multiple tabs, each including one or more widgets that include visualizations that are based on the vulnerability data, tie the vulnerabilities to associated CIs, services, and/or responsible parties, and/or track changes in the vulnerabilities over time. At block 1012 the GUI is transmitted to a client device, another computing device, or to a display device for display to a user. The user may then make selections within the GUI and manipulate the GUI as desired. In some embodiments, the GUI may be updated in response to manipulations and/or inputs provided by the user.

The disclosed techniques include a vulnerability scorecard that correlates a vulnerability detected for a network-connected host, with an underlying CI, services that may my run on, depend from, or otherwise utilize the CI, and the service owners responsible for the services. The vulnerability scorecard may include a GUI that includes window, widgets, and/or other visualizations that represent data related to the vulnerabilities, CIs, services, service owners, etc. The vulnerability scorecard widgets may be separated into groups and distributed over pages organized by tabs. Accordingly, adjustments may be made (e.g., resources allocated or reallocated, communications sent, etc.)

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
one or more hardware processors; and
a non-transitory memory, accessible by the one or more hardware processors, and storing instructions that, when executed by the one or more hardware processors, cause the one or more hardware processors to perform operations comprising:
receiving identification of a network vulnerability experienced by a resource of a computing network and an identification of the resource experiencing the network vulnerability;
identifying a configuration item (CI) of a configuration management database (CMDB) associated with the resource based on the identification of the resource experiencing the network vulnerability;
identifying one or more services associated with the identified CI that may be affected by the network vulnerability;
identifying one or more parties responsible for managing the one or more identified services; and
generating a graphical user interface (GUI) comprising one or more visualizations that associate the identified network vulnerability with the one or more identified CIs affected by the identified network vulnerability, the one or more identified services affected by the identified network vulnerability, the one or more identified parties responsible for managing the one or more identified services, or a combination thereof.

2. The system of claim 1, wherein the GUI displays a number of active network vulnerabilities experienced by the computing network.

3. The system of claim 1, wherein the GUI displays a number of vulnerable CIs within the computing network, wherein the CI associated with the resource experiencing the network vulnerability is a vulnerable CI.

4. The system of claim 1, wherein the one or more visualizations comprise a heatmap illustrating risk rating and vulnerability age for a plurality of network vulnerabilities experienced by the computing network.

5. The system of claim 1, wherein the one or more visualizations comprise a listing of a number of critical vulnerabilities assigned to each of a plurality of assignment groups.

6. The system of claim 1, wherein the one or more visualizations comprise a listing of a number of overdue vulnerabilities assigned to each of a plurality of assignment groups.

7. The system of claim 1, wherein the one or more visualizations comprise a widget illustrating a number of vulnerabilities experienced by each of a plurality of CIs.

8. The system of claim 7, wherein the widget comprises a Pareto chart.

9. The system of claim 7, wherein the widget comprises a treemap.

10. The system of claim 1, wherein the one or more visualizations comprise a listing of a plurality of responsible parties for a plurality of services and a number of vulnerabilities experienced by the services managed by each responsible party.

11. The system of claim 1, wherein the one or more visualizations comprise a time series plot of a number of vulnerabilities experienced by associated services managed by a selected responsible party.

12. A method, comprising:
receiving, via a processor, identification of a network vulnerability experienced by a resource of a computing network and an internet protocol (IP) address associated with the resource experiencing the network vulnerability;
identifying, via the processor, a configuration item (CI) of a configuration management database (CMDB) associated with the resource based on the IP address;
identifying, via the processor, one or more services associated with the identified CI that may be affected by the network vulnerability;
identifying, via the processor, one or more parties responsible for managing the one or more identified services;
generating, via the processor, a graphical user interface (GUI) comprising one or more visualizations that associate the identified network vulnerability with the one or more identified CIs affected by the identified network vulnerability, the one or more identified services affected by the identified network vulnerability, the one or more identified parties responsible for managing the one or more identified services, or a combination thereof; and
transmitting, via the processor, the GUI for display.

13. The method of claim 12, comprising:
receiving, via the processor, an input manipulating the GUI;
updating, via the processor, the GUI in response to the manipulation; and
transmitting, via the processor, the updated GUI for display.

14. The method of claim 12, wherein the one or more visualizations comprises a number of vulnerabilities assigned to each of a plurality of assignment groups.

15. The method of claim 12, wherein the one or more visualizations comprise a listing of a plurality of responsible parties for a plurality of services and a number of vulnerabilities experienced by services managed by each responsible party.

16. The method of claim 15, wherein the one or more visualizations comprise a time series plot of a number of vulnerabilities experienced by associated services managed by a selected responsible party.

17. A non-transitory, tangible, computer-readable medium comprising instructions that, when executed by a processor, causes the processor to perform operations comprising:
generating a graphical user interface (GUI), wherein the GUI comprises one or more visualizations that associate one or more identified network vulnerabilities experienced by a resource of a computing network with one or more configuration items (CIs) affected by each of the one or more identified network vulnerabilities, one or more services affected by each of the one or more identified network vulnerabilities, one or more parties responsible for the one or more services affected by each of the one or more identified network vulnerabilities, or a combination thereof.

18. The non-transitory, tangible, computer-readable medium of claim 17, the operations comprising:
identifying the one or more configuration items (CI) listed in a configuration management database (CMDB) associated with the resource experiencing the network vulnerability;
identifying the one or more services associated with the one or more CIs that may be affected by the network vulnerability; and
identifying the one or more parties responsible for managing the one or more services.

19. The non-transitory, tangible, computer-readable medium of claim 17, wherein the one or more visualizations comprise a time series plot of a number of vulnerabilities experienced by associated services managed by a selected responsible party.

20. The non-transitory, tangible, computer-readable medium of claim 19, wherein the one or more visualizations comprise a time series plot of a number of vulnerabilities experienced by associated services managed by a selected responsible party.
